(19) United States
(12) Patent Application Publication
(10) Pub. No.: US 2013/0185996 A1
(43) Pub. Date: Jul. 25, 2013

(54) PLANT CULTIVATION STRUCTURE AND SOIL FOR PLANT CULTIVATION

(71) Applicant: Panasonic Corporation, Osaka (JP)

(72) Inventor: Sachio NAGAMITSU, Kyoto (JP)

(73) Assignee: Panasonic Corporation, Osaka (JP)

(21) Appl. No.: 13/790,371

(22) Filed: Mar. 8, 2013

Related U.S. Application Data
(63) Continuation of application No. PCT/JP2012/003369, filed on May 23, 2012.

(30) Foreign Application Priority Data
Jun. 1, 2011 (JP) 2011-122999
Jan. 20, 2012 (JP) 2012-010363

(51) Int. Cl. A01G 1/00

(52) U.S. Cl. CPC A01G 1/00
USPC 47/58.1 R

(57) ABSTRACT

There is provided a structure including water repellent sand obtained by applying water repellent coating to sand, a plant having roots that grow in the water repellent sand, and a plurality of water retaining layers scattered in the water repellent sand, such that each of the roots grows to reach at least one of the water retaining layers.

### CROSS-REFERENCE TO RELATED APPLICATIONS

This is a continuation application of International Application No. PCT/JP2012/003369, with an international filing date of May 23, 2012, which claims priority of Japanese Patent Application No.: 2011-122999 filed on Jun. 1, 2011, the content of which is incorporated herein by reference.

### TECHNICAL FIELD

The technical field relates to a plant cultivation structure and soil (soil structure) for plant cultivation that are applicable to hydroponic culture with use of sand having a water repellent property.

### BACKGROUND ART

As to the technique for improvement of soil so as to be desired by human race at the level of the environment of the earth, in view of the food crisis, there is an attempt to improve the structure of soil for better growth of farm products as well as for better production efficiency. In particular, there has been made an invention relating to the improvement of soil as innovation for retaining water that is often insufficient in desertified land, in which sand itself existing enormously on site is utilized by applying water repellent coating thereto.

As an example of conventional improvement of soil, there has been made an invention in which a hydrophobic layer configured by hydrophobic particles is provided on soil including a water retaining agent with a layer of soil including no water retaining agent being interposed therebetween (see JP 3057304 B1, for example). As shown in FIG. 8A, ordinary soil 51 is provided on a water retaining agent layer 50 including a water retaining agent, and a hydrophobic layer 52 is provided thereon so as to prevent evaporation of water. As shown in FIG. 8B, there is described a configuration in which another ordinary soil 51 is provided on a top of the configuration shown in FIG. 8A, or the hydrophobic layer 52 is provided on the water retaining agent layer 50 and the ordinary soil 51 is provided on the water retaining agent layer 50. The ordinary soil 51 is 10 to 100 mm in thickness. As shown in FIG. 8C, there is also a configuration in which the hydrophobic layer 52 is provided therein with the ordinary soil 51 penetrating the hydrophobic layer 52 so as not to have partially hydrophobicity. In this configuration, the hydrophobic layer 52 is provided on the water retaining agent layer 50 so as to prevent evaporation. Furthermore, the layer of the ordinary soil 51 is provided on the hydrophobic layer 52 so as to protect the hydrophobic layer 52 from sunlight or wind.

### SUMMARY OF THE INVENTION

However, the soil structures described above still have issues.

The measure according to JP 3057304 B1 basically has the following defect. Specifically, because of provision of the hydrophobic layer 52, water poured on a ground surface 30 is unlikely to reach the water retaining agent layer 50. According to JP 3057304 B1, as shown in FIG. 8C, the ordinary soil 51 having no hydrophobicity is partially provided in the hydrophobic layer 52 or so as to penetrate the hydrophobic layer 52. Ina case where the structure is used for planting a plant, it may be effective in some cases to remove hydrophobicity only in the limited portion for planting the plant on the surface of the soil. In this case, even when water is poured on the ground surface 30, the water permeates quite rapidly into the soil, and passes through or avoids the hydrophobic layer 52, so as to reach the water retaining agent and be retained therein.

However, still in this case, it is difficult for only an appropriate amount of water necessary for the plant is to reach the ordinary soil 51 or the water retaining agent layer 50 and be retained therein. There is a defect that the amount of supply needs to be controlled accurately. Even in a case where too much water is supplied, the water is excessively absorbed in the ordinary soil 51, or the excessive water remains on the water retaining agent layer 50. Therefore, air may not be appropriately supplied to the plant thereby to cause root rot. On the contrary, in a case where water is insufficient because the amount of water passing through the hydrophobic layer 52 is not controlled accurately, the plant cannot grow appropriately.

One non-limiting and exemplary embodiment provides a plant cultivation structure and soil for plant cultivation, which enable supply of requisite minimum water as well as supply of air to roots of a plant.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

In one general aspect, the techniques disclosed here feature: a plant cultivation structure comprising:

a water repellent sand layer that is formed by water repellent sand having surfaces to which water repellent coating is applied;

a plurality of water retaining layers scattered in the water repellent sand layer in a depth direction of the water repellent sand layer and capable of retaining water; and

a plant having roots located in the water repellent sand layer and being in contact with the water retaining layers such that the roots connect the plurality of water retaining layers.

These general and specific aspects may be implemented using a system, a method, or any appropriate combination of such a system and a method.

In the plant cultivation structure and the soil for plant cultivation according to the above aspects of the present invention, requisite minimum water can be supplied to plants individually in accordance with the different growth speeds of the respective plants. Furthermore, air can also be supplied to the roots of the plants. As a result, hydroponic culture can be enabled with high efficiency and high quality.

### BRIEF DESCRIPTION OF DRAWINGS

These and other aspects and features of the present invention will become clear from the following description taken in conjunction with the embodiments thereof with reference to the accompanying drawings, in which:

FIG. 1A is a sectional view showing a state after supply of water in a plant cultivation structure according to a first embodiment of the present invention;

FIG. 1B is a sectional view of the plant cultivation structure according to the first embodiment of the present invention, in a state where roots of a plant have grown from the state shown in FIG. 1A;

FIG. 1C is a sectional view of the plant cultivation structure according to the first embodiment of the present invention, in a state where the roots of the plant have grown from the state shown in FIG. 1B;

FIG. 1D is a sectional view showing a state before supply of water in the plant cultivation structure according to the first embodiment of the present invention;

FIG. 1E is a sectional view showing a state before supply of water in a plant cultivation structure according to a modification of the first embodiment of the present invention;

FIG. 1F is a sectional view showing a state after supply of water in the plant cultivation structure according to the modification of the first embodiment of the present invention;

FIG. 2A is a sectional view showing configurations of water retaining layers each having a circular arc shape in cross section, in the plant cultivation structure according to another modification of the first embodiment of the present invention;

FIG. 2B is a sectional view showing configurations of water retaining layers in a plant cultivation structure according to the first embodiment combined with the modification in the present invention;

FIG. 3 is a sectional view showing configurations of layered water retaining layers in a plant cultivation structure according to still another modification of the first embodiment of the present invention;

FIG. 4 is a view of a test system for explanation of a basic principle in the plant cultivation structure according to the first embodiment of the present invention;

FIG. 5A is a view of the test system for explanation of the basic principle in the plant cultivation structure according to the first embodiment of the present invention;

FIG. 5B is a view of the test system for explanation of the basic principle in the plant cultivation structure according to the first embodiment of the present invention;

FIG. 5C is a view of the test system for explanation of the basic principle in the plant cultivation structure according to the first embodiment of the present invention;

FIG. 6 is a sectional view of a test system for explanation of the basic principle in the plant cultivation structure according to the first embodiment of the present invention;

FIG. 7A is an explanatory view illustrating a working example in connection with evaluation results on a plant in the plant cultivation structure according to the first embodiment of the present invention;

FIG. 7B is an explanatory view illustrating the working example in connection with the evaluation results on the plant in the plant cultivation structure according to the first embodiment of the present invention;

FIG. 7C is an explanatory view illustrating the example in connection with the evaluation results on the plant in the plant cultivation structure according to the first embodiment of the present invention;

FIG. 7D is a view showing an image of conventional supply of water;

FIG. 7E is a view showing an image of supply of water in the aspect of the present invention, for supplementary explanation of one of the features according to an aspect of the present invention, specifically, “enabling supply of requisite minimum water as well as supply of air to roots of a plant”;

FIG. 8A is a view showing a configuration of soil that enables retention of water and prevention of water evaporation by means of conventional water repellent sand;

FIG. 8B is a view showing a configuration of soil that enables retention of water and prevention of water evaporation by means of conventional water repellent sand; and

FIG. 8C is a view showing a configuration of soil that enables retention of water and prevention of water evaporation by means of conventional water repellent sand.

### DETAILED DESCRIPTION

Embodiments of the present invention are detailed below with reference to the drawings.

First, the basic concept of the present disclosure is explained.

Examples of the disclosed technique are as follows.

1st aspect: a plant cultivation structure comprising:

a water repellent sand layer including water repellent sand having surfaces to which water repellent coating is applied;

a plurality of water retaining layers scattered in the water repellent sand layer in a depth direction of the water repellent sand layer and capable of retaining water; and

a plant having roots located in the water repellent sand layer and being in contact with the water retaining layers such that the roots connect the plurality of water retaining layers.

According to the 1st aspect, requisite minimum water can be supplied to plants individually in accordance with the different growth speeds of the respective plants. Furthermore, air can also be supplied to the roots of the plants. As a result, hydroponic culture can be enabled with high efficiency and high quality.

2nd aspect: the plant cultivation structure according to the 1st aspect, wherein, in the plurality of water retaining layers, the water retaining layer in contact with the root of the plant retains water that is supplied from outside the water repellent sand layer to the plant and moves along the root of the plant.

According to the 2nd aspect, requisite minimum water can be supplied to the plants individually in accordance with the different growth speeds of the respective plants. Furthermore, air can also be supplied to the roots of the plants. The water is retained in the water retaining layers even while the water is not supplied. Therefore, air can also be supplied to the roots of the plants, thereby to achieve hydroponic culture with high efficiency and high quality.

3rd aspect: the plant cultivation structure according to the 1st or 2nd aspect, wherein each of the water retaining layers contains a manure composition.

According to the 3rd aspect, requisite minimum water and manure can be supplied to the plants individually in accordance with different growing speeds of the plants. Furthermore, air can also be supplied to the roots of the plants. As a result, hydroponic culture can be enabled with high efficiency and high quality.

4th aspect: the plant cultivation structure according to any one of the 1st to 3rd aspects, wherein the water retained in the water retaining layers contains a manure composition.

According to the 4th aspect, requisite minimum water and manure can be supplied to the plants individually in accordance with different growing speeds of the plants. Furthermore, air can also be supplied to the roots of the plants. As a result, hydroponic culture can be enabled with high efficiency and high quality.

5th aspect: the plant cultivation structure according to any one of the 1st to 4th aspects, wherein the water retaining layers are formed by sand with no water repellent coating.

According to the 5th aspect, the water retaining layers is formed by the sand with no water repellent coating, so as to have a water retentive property (in other words, a water absorbing property) and exert the water retentive property.

6th aspect: the plant cultivation structure according to any one of the 1st to 5th aspects, wherein each of the water retaining layers is formed into a downwardly convex circular arc shape in the depth direction.

According to the 6th aspect, when the plurality of plants are provided, the structure is compatible with the roots growing substantially concentrically in planar view, of the individual plants. Furthermore, the roots reliably pass through the water retaining layers even in a case where the roots grow randomly and unexpectedly in various directions. Therefore, such a structure is useful.

7th aspect: the plant cultivation structure according to any one of the 1st to 5th aspects, wherein the water retaining layers are scattered and layered in the depth direction.

According to the 7th aspect, the roots can grow by reliably passing through the water retaining layers.

8th aspect: the plant cultivation structure according to any one of the 1st to 7th aspects, wherein the water repellent sand layer has a concavity for supply of water, in a surface in a portion where the plant is planted.

According to the 8th aspect, there is provided the concavity for supply of water, so that the water is likely to be retained temporarily in the concavity. More specifically, for example, by supplying water from a watering pot or the like toward the concavity or the ground surface upon supplying water, the water can be easily and reliably retained in the concavity. Furthermore, if water is sprinkled over an upper portion of the plant, such as leaves, water runs from the leaves along a stem so as to be easily collected into the concavity. Therefore, the water can be easily and reliably retained in the concavity.

9th aspect: the plant cultivation structure according to any one of the 1st to 8th aspects, wherein the water repellent sand layer is formed by the water repellent sand having the surfaces to which water repellent coating is applied, and sand with no water repellent coating mixed thereto.

According to the 9th aspect, effects similar to those of the case of including only the water repellent sand can be achieved also in a case where the water repellent sand layer further is formed by sand with no water repellent coating mixed with the water repellent sand to the surfaces of which water repellent coating is applied.

10th aspect: soil (soil structure) for plant cultivation, comprising:

a water repellent sand layer that is formed by water repellent sand having surfaces to which water repellent coating is applied; and

a plurality of water retaining layers scattered in the water repellent sand layer in a depth direction of the water repellent sand layer and capable of retaining water, wherein

the water retaining layers are in contact with roots of a plant in the water repellent sand layer, the roots grow so as to connect the plurality of water retaining layers, and the water retaining layers retain water that is supplied from outside the water repellent sand layer to the plant and moves along the roots of the plant.

According to the 10th aspect, requisite minimum water can be supplied to plants individually in accordance with the different growth speeds of the respective plants. Furthermore, air can also be supplied to the roots of the plants. As a result, hydroponic culture can be enabled with high efficiency and high quality.

11th aspect: the soil for plant cultivation according to the 10th aspect, wherein the water repellent sand layer is formed by the water repellent sand having the surfaces to which water repellent coating is applied, and sand with no water repellent coating mixed thereinto.

According to the 11th aspect, effects similar to those of the case of including only the water repellent sand can be achieved also in a case where the water repellent sand layer further is formed by sand with no water repellent coating mixed with the water repellent sand to the surfaces of which water repellent coating is applied.

Embodiments of the present invention are described below with reference to the drawings.

### First Embodiment

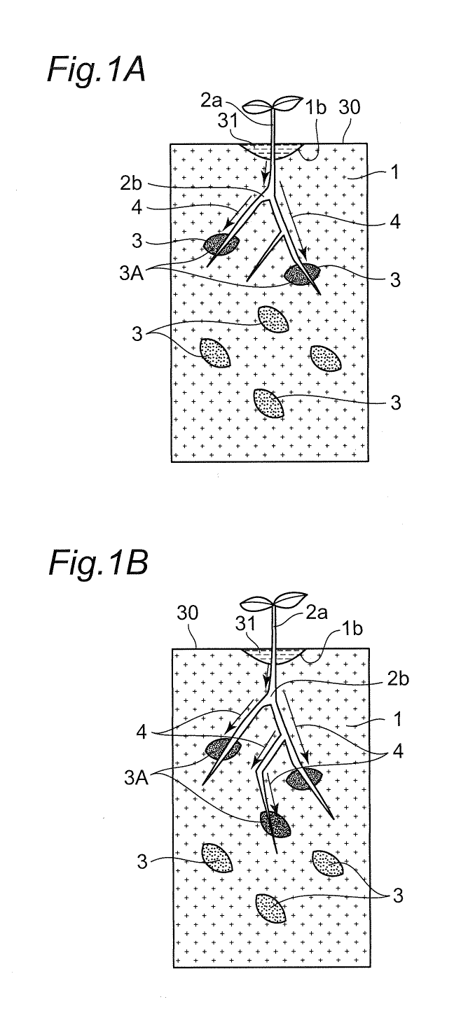

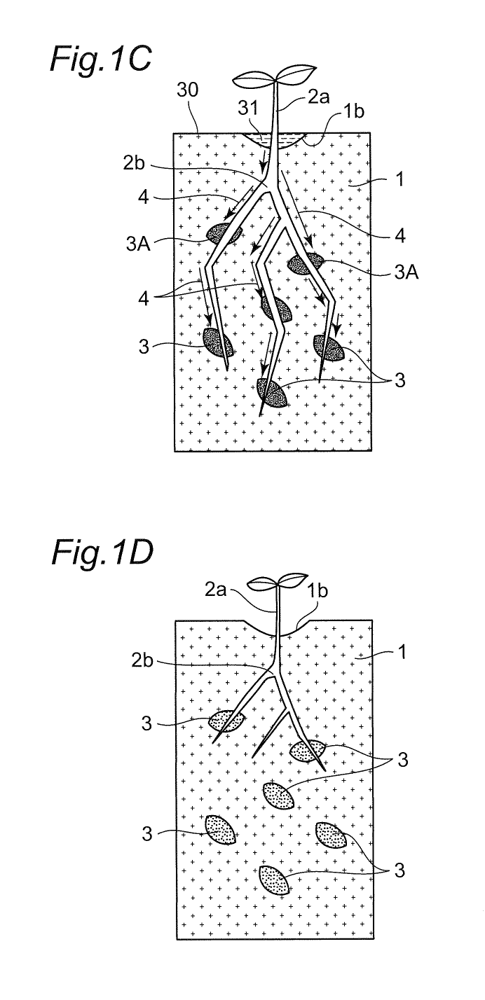

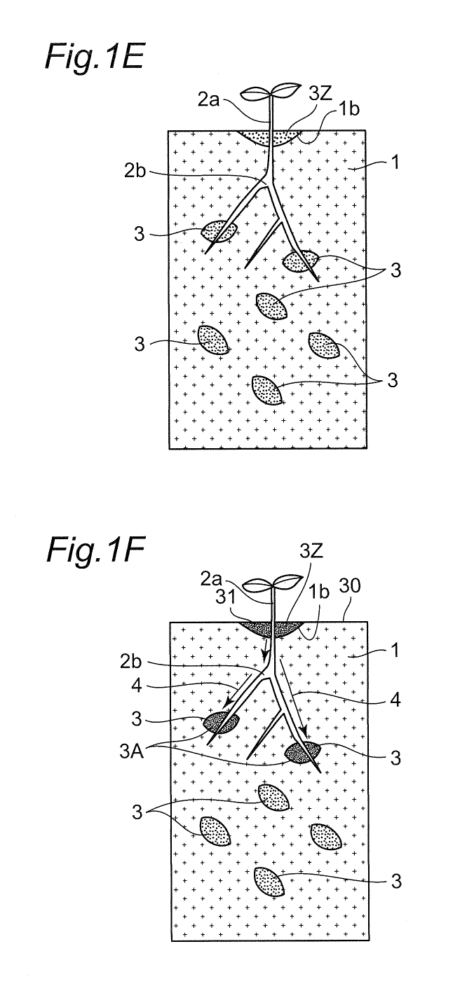

FIGS. 1A to 1D are views each showing a plant cultivation structure according to the first embodiment of the present invention. The plant cultivation structure serves also as a water and manure supply system (or a water supply system).

In each of FIGS. 1A to 1D, the plant cultivation structure is formed by a water repellent sand layer 1, water retaining layers 3, and a plant 2a. The plant 2a may be arbitrarily selected as long as roots 2b grow in the water repellent sand layer 1. Examples of the plant 2a include root vegetables such as a radish and a carrot. The water repellent sand layer 1 and the water retaining layers 3 configure soil for plant cultivation.

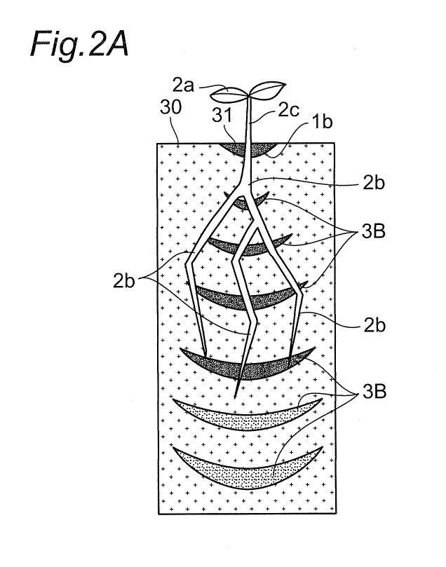

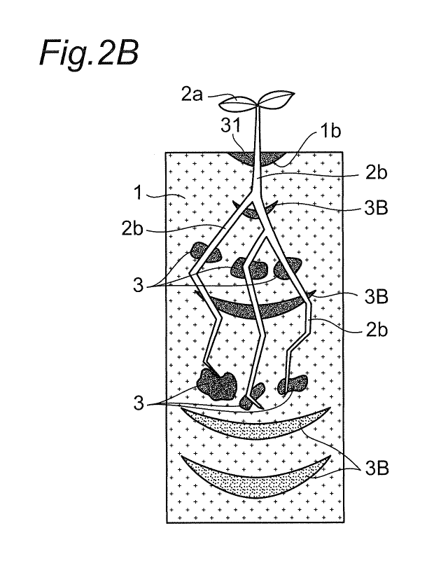

The water repellent sand layer 1 is formed by applying water repellent coating to sand. For example, a portion where the plant 2a is planted is provided with a concavity 1b for supply of water, such that water 31 can be likely retained temporarily (see FIG. 1D). The water repellent sand obtained by applying water repellent coating to sand is less likely to allow water to pass therethrough. In addition, water tends to run on the surface of a mass of sand. It is because the surface of the mass of sand is not perfectly horizontal in many cases. Thus, the concavity 1b for supply of water is provided to easily and reliably retain the water 31. The concavity is also useful upon supplying water (watering). More specifically, in an efficient water-supplying method, water is supplied from a watering pot or the like toward the concavity 1b or a grounded portion 2c (indicated in FIG. 2A to be described later) upon watering. For example, it is further possible to sprinkle an upper portion of the plant 2a, such as leaves, so that water runs from the leaves along a stem so as to be easily collected in the concavity 1b.

The concavity 1b for supply of water may not be formed simply as a concave portion. The concavity 1b may be provided therein with sand capable of retaining water, such as ordinary sand 3Z with no water repellent coating (sand to which water repellent coating is not applied), so as to have a water retentive property (see FIGS. 1E and 1F). In this manner, it is possible to prevent water from running away from the concave by wind and evaporating. Because water is kept absorbed to the ordinary sand, the roots located thereabove may rot, or water and manure remaining there do not reach the target roots inefficiently, resulting in poor efficiency. In such a case where the ordinary sand 3Z provided in the concavity 1b causes water to remain for a long period of time or inhibits efficient supply of water to the roots 2b, for example, it is possible in some cases not to provide the ordinary sand 3Z in the concavity 1b as mentioned above but to supply water directly into the concavity 1b. It is necessary to appropriately decide whether or not to provide the ordinary sand 3Z in the concavity 1b, in accordance with the degree of drainage of the ordinary sand 3Z, the speed of water supplied to the roots 2b, or the amount of water necessary for the plant 2a. In some cases, for example, the amount of the ordinary sand 3Z provided in the concavity 1b may be controlled, or the ordinary sand 3Z provided in the concavity 1b may form a concave upper surface thereof.

The water retaining layers 3 have the water retentive property (in other words, a water absorbing property). The water repellent sand layer 1 is provided therein with the plurality of water retaining layers 3 that are scattered (not mixed) in the depth direction of the water repellent sand layer 1. In FIGS. 1A to 1D, the water retaining layers 3 in black have already retained water, while the water retaining layers 3 in gray are capable of retaining water. The water retaining layers 3 may be located at any positions. Even in a case where the water retaining layers are located randomly, the water retaining layers 3 are still capable of retaining a small amount of water that soaks from a ground surface 30 into the water repellent sand layer 1. As a result, the roots 2b of the plant 2a grow toward such a small amount of water in the water retaining layers 3, or grow mainly in the vertical direction with some expansion as the original nature of the plant 2a. Then, the roots 2b of the plant 2a reach and contact with the water retaining layers 3, such that each of the roots connects the plurality of water retaining layers 3. Therefore, there is no particular limitation to the positions of the water retaining layers 3, as long as the water retaining layers are scattered in the depth direction. Each of the roots 2b of the plant 2a have only to be located so as to connect at least two of the water retaining layers 3 provided in the water repellent sand layer 1. Alternatively, each of the roots 2b of the plant 2a may be located so as to connect all of the water retaining layers 3 provided in the water repellent sand layer 1. The water retaining layers 3 may be configured variously: namely, by simply containing only sand with no water repellent coating so as to have the water retentive property; containing ordinary soil with clay so as to have the water retentive property; adding water repellent sand to be mixed so as to have the water retentive property; containing a polymer material having water retentivity, and the like so as to have the water retentive property; further containing manure necessary for growth of the plant so as to have the water retentive property; combining any of the above so as to have the water retentive property; and the like.

When the roots 2b of the plant 2a grow to reach the water retaining layers 3, the water 31 supplied to the plant 2a in the region facing the outer surface of the water repellent sand layer 1 (such as the ground surface 30) moves in the water repellent sand layer 1 along the surfaces of the roots 2b to reach the water retaining layers 3 as indicated as water supply routes 4, and is retained in the water retaining layers 3. Among the large number of water retaining layers 3, the water retaining layers 3 retaining the water thus moved are painted in black (see reference sign 3A). For example, the water retaining layers 3 can retain the water for about two to three days. The water retained in each of the water retaining layers 3 is absorbed by the root 2b that is in contact with the water retaining layer 3. The roots 2b of the plant 2a are capable of forming the water supply routes 4 because the roots 2b of the plant 2a have hydrophilic surfaces.

In FIG. 2A, as the water retaining layers 3, water retaining layers 3B are aligned vertically in the growing direction of the roots 2b and each have a downwardly convex circular arc shape in the depth direction. Thus, the water retaining layers 3B are each formed into the circular arc shape in vertical cross section with a substantial center located at the grounded portion 2c of the plant 2a exposed to the ground surface. In this configuration, consideration is made to the nature that the roots 2b of the plant 2a grow vertically downward (downward in the depth direction) with expansion in the horizontal direction. The water retaining layers 3B are provided in accordance with such growth of the roots 2b, so that the roots 2b pass through the water retaining layers 3B with higher probability. FIG. 2A shows the case where the water retaining layers 3B in the circular arc shapes are made gradually larger as the water retaining layers are located deeper in the depth direction. However, the present disclosure is not limited to this case. When the water retaining layers 3B in the circular arc shapes are made gradually larger as the water retaining layers are located deeper in the depth direction, the roots 2b of the plant 2a contact with the water retaining layers 3B with high possibility even if the roots grow downward in the depth direction gradually with larger expansion.

FIG. 2B shows a case of combining the plurality of water retaining layers 3 that are scattered in the depth direction of the water repellent sand layer 1 shown in FIG. 1A, with the water retaining layers 3B shown in FIG. 2A, which are aligned vertically in the growing direction of the roots 2b and each have a downwardly convex circular arc shape in the depth direction. This system has both the property of the water retaining layers 3 and the property of the water retaining layers 3B.

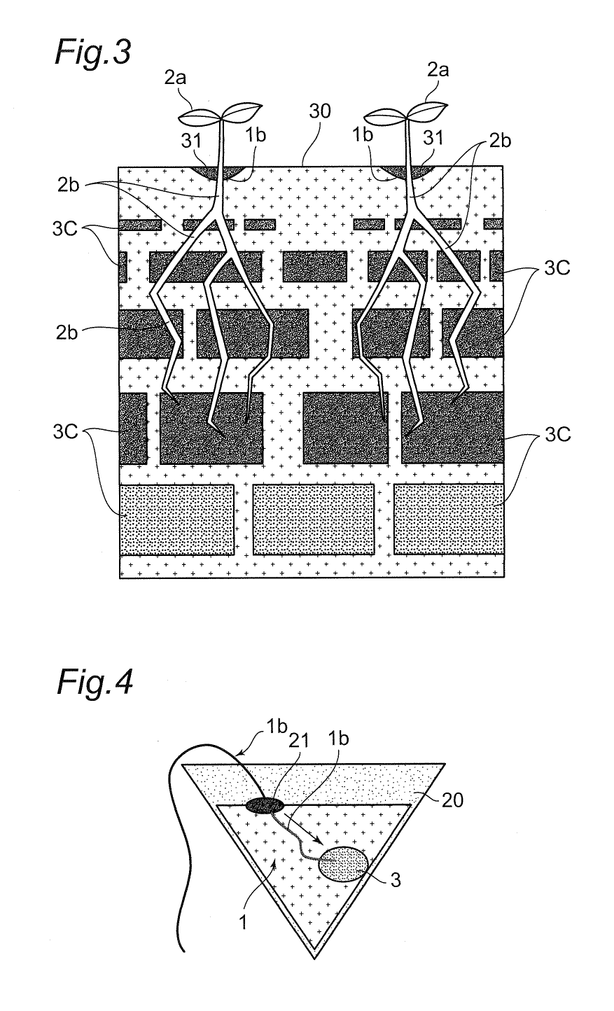

In FIG. 3, as the water retaining layers 3, water retaining layers 3C are scattered vertically in the growing direction of the roots 2b (in the depth direction), as well as horizontally, so as to form layers. Unlike the case shown in FIG. 2A, FIG. 3 shows the configuration applicable also to a case where there are a plurality of plants 2a (more specifically, the plant 2a on the right in addition to the plant 2a on the left in FIG. 3). More specifically, the configuration shown in FIG. 2A is useful for the single plant 2a or the plurality of plants 2a spaced largely apart from each other, the roots 2b of which grow without getting close to each other. However, in the case shown in FIG. 3 where the plurality of plants 2a are located relatively close to each other, the water retaining layers 3C being scattered and layered are practical. More specifically, when the water retaining layers 3C are scattered horizontally as well as vertically (the depth direction) in the growing direction of the roots 2b so as to form the layers, the roots 2b of the plurality of plants 2a can independently contact with the water retaining layers 3C, so that the roots 2b can absorb sufficient water from the water retaining layers 3C, respectively. To the contrary, in the case shown in FIG. 2A where the water retaining layers 3B are not scattered horizontally and only one water retaining layer is located at a same depth level, the root 2b having firstly reached one of the water retaining layers 3B can absorb sufficient water, while the root 2b later reaching the same water retaining layer 3B may not be able to absorb sufficient water. The water retaining layers 30 shown in FIG. 3 can prevent such a defect. In FIG. 3, the water retaining layers 3C are gradually increased in thickness as the water retaining layers are located deeper in the depth direction, so that the roots 2b of the plants 2a can sufficiently absorb more water as the roots grow deeper in the depth direction.

In the configurations shown in FIGS. 1A to 3 according to the first embodiment, when each of the roots 2b of the plant 2a grows to reach at least one of the water retaining layers 3, 3B, or 3C, water supplied to the plant 2a in the region facing the outer surface of the water repellent sand layer 1 (such as the ground surface 30) moves in the water repellent sand layer 1 along the surface of the root 2b to reach the water retaining layer 3, 3B, or 3C as indicated as the water supply route 4. The water having reached the water retaining layer 3, 3B, or 3C is reserved in the water retaining layer 3, 3B, or 3C. Each of the roots 2b of the plant 2a grows by absorbing the water reserved in the water retaining layer 3, 3B, or 3C.

The plant 2a is cultivated, each of the roots 2b also grows to reach another water retaining layer 3, 3B, or 3C that is located below in the depth direction or aside in the horizontal direction. Similarly, water supplied to the ground surface 30 or the like moves along the water supply route 4 of the root 2b so as to be reserved in the water retaining layer 3, 3B, or 3C, and the water thus reserved is absorbed by the root 2b. This cycle is repeated. As a result, as the plant 2a is cultivated, each of the roots 2b contacts with the water retaining layers 3, 3B, or 3C so as to connect the plurality of water retaining layers 3, 3B, or 3C. In this manner, necessary water is reserved in the water retaining layers 3, 3B, or 3C as the roots 2b grow, so that the plant 2a can absorb the water through the roots 2b. In other words, the plant 2a can be cultivated with supply of requisite minimum water (by allowing only an appropriate amount of water necessary for the plant 2a to move from the ground surface 30 to reach the roots 2b by way of the water retaining layers 3, 3B, or 3C). After the supply of water, because the water repellent sand layer 1 has the property of allowing evaporated water to pass therethrough, in the water having flown along the surfaces of the roots 2b, water not retained in the water retaining layers 3, 3B, or 30 but remained on the roots 2b is instantly evaporated and disappeared through the water repellent sand layer 1. Meanwhile, the roots 2b are supplied with air from the region facing the outer surface of the water repellent sand layer 1 through the water repellent sand layer 1. Therefore, necessary air can also be supplied to the roots 2b.

Particularly when the plurality of plants 2a are cultivated, the plants 2a individually grow at different speed in many cases. Also in such a case, the number of the water retaining layers 3, 3B, or 3C in contact with each of the roots 2b is increased as the root 2b grows, and water can be appropriately supplied to the root 2b. Such a feature is remarkably advantageous in practical use.

In a case where the scattered and layered water retaining layers 3C shown in FIG. 3 are horizontally connected with each other to form continuous layers, it is possible to realize substantially the same effects.

In conventional hydroponic culture, there have been the following issues. Specifically, relatively to the amount of water and the amount of manure necessary for a plant, water and manure are inefficiently supplied also to a portion of a culture medium where there is no root. Furthermore, water and manure remain excessively around a root of a plant so as to cause insufficient supply of air to the root.

To the contrary, according to the first embodiment, in accordance with the different growth speeds of the respective plants 2a, requisite minimum water or water and manure can be supplied individually to the plants 2a. Furthermore, air can also be supplied to the roots 2b of the plants 2a. As a result, hydroponic culture can be enabled with high efficiency and high quality.

The configuration of the water retaining layers 3B shown in FIG. 2A is compatible with the roots 2b, which grow substantially concentrically in planar view, of the individual plants 2a. Furthermore, unlike the configurations shown in FIGS. 1A to 1F, the roots 2b reliably pass through the water retaining layers 3B even in a case where the roots 2b grow randomly and unexpectedly in various directions. Therefore, the configuration shown in FIG. 2A is useful.

Similarly to the configuration shown in FIG. 2A, the configuration of the water retaining layers 3C shown in FIG. 3 is characterized in that the roots 2b of the plurality of plants 2a can grow by reliably passing through the water retaining layers 3C.

Similar effects can be achieved also in a case where the water retaining layers 3, 3B, or 3C preliminarily contain manure.

To the contrary, similar effects are also achieved by adding a manure composition into a water composition to be supplied to the water retaining layers 3, 3B, or 3C. In this case, similar effects are also achieved when each of the water retaining layers 3, 3B, or 3C is configured by ordinary sand with no water repellent coating.

Alternatively, similar effects are achieved also in a case where the water retaining layers 3, 3B, or 3C are configured by ordinary sand containing a water retaining agent.

Still alternatively, similar effects can be achieved by adding a manure composition to the water retaining layers 3, 3B, or 3C. Even if water to be supplied does not contain any manure composition, the water retaining layers 3, 3B, or 3C themselves exert the property of manure when water is supplied thereto.

There is a recent research that a plant is cultivated faster or a grown plant has a higher nutritional value by controlling to appropriately supply minimum water or manure to the plant rather than by supplying sufficient water or manure. For these purposes, it is an important issue to accurately control the amount of water or manure to be supplied in accordance with the growth of the plant. As to such an issue, by applying the first embodiment, water or manure is not excessively supplied to soil around the plant to improve accuracy of quantitative supply of water or manure. In particular, only a necessary amount of water or manure can be supplied to the peripheries of the roots of the plant, so as to easily and accurately control the amount of water or manure to be supplied. According to the first embodiment of the present disclosure, water or manure is not allowed to pass excessively or unlimitedly through the peripheral soil as in the conventional case. Furthermore, after sufficiently supplied along the roots, excessive water or manure does not flow in the soil along the roots, so as to easily detect the necessary amount of supply. As a result, it is possible to control the amount of supply by feedback.

In a case where a chlorosilane-based compound is used as a surface treatment compound for applying water repellent coating to sand, surface treatment can be made with a monomolecular, so that the shapes of the surfaces are not changed by repetition. Therefore, the plant 2a can be cultivated similarly to the case of using ordinary soil.

Described below is preparation of soil for plant cultivation in the configurations shown in FIGS. 1A to 3 according to the first embodiment. The following description exemplifies a case where sand with no water repellent coating, in other words, ordinary sand, is used as a material for the water retaining layers 3, 3B, or 3C. The ordinary sand generally has a property of being aggregated by water. The ordinary sand containing water can be aggregated into substantially a spherical shape like the water retaining layer 3 shown in FIG. 1A, a circular arc shape like the water retaining layer 3B shown in FIG. 2A, or a rectangular shape like the water retaining layer 3C shown in FIG. 3. In order to prepare the soil for plant cultivation shown in FIG. 2A or 3, the water repellent sand layers 1 made of water repellent sand and the water retaining layers 3B or 3C made of ordinary sand containing water and having been aggregated into the predetermined shape are alternately laminated from the bottom to the top in order. In this manner, it is possible to prepare the soil for plant cultivation in which the water repellent sand layers 1 and the water retaining layers 3B or 3C are laminated alternately.

In the case of the water retaining layers 3 having substantially the spherical shapes as shown in FIG. 1A, the water retaining layers 3 having been aggregated into the spherical shapes have only to be preliminarily mixed in water repellent sand. The water repellent sand containing the plurality of water retaining layers 3 may be located as the water repellent sand layer 1 including the water retaining layers 3, with no need to prepare the layers from the bottom to the top as described above. In this manner, it is possible to easily provide the soil for plant cultivation.

Use of manure is a promising example of the water retaining layers 3 that are capable of retaining water without containing ordinary sand. Most manure has a property as a solid matter by aggregating without water, unlike ordinary sand. If manure is solid and is shaped in aggregates larger than grains, such manure often works slowly as laid manure. In order to prepare soil for plant cultivation, solid manure has only to be added and mixed into water repellent sand. The manure is easily scattered in the water repellent sand layer 1 only by mixing thereinto, so as to prepare the soil for plant cultivation including the water retaining layers 3 having substantially the spherical shapes as shown in FIG. 1A. Therefore, use of solid manure as the water retaining layers 3 is regarded as one of the easiest, efficient, and practical methods of preparing soil for plant cultivation. The soil for plant cultivation prepared according to such a method corresponds to the case where the water retaining layers 3 are configured by manure as shown in FIG. 1.

Described next is a test for explaining the basic principle of the plant cultivation structure according to the first embodiment of the present invention. FIGS. 4 to 6 each show a test system for explanation of the basic principle.

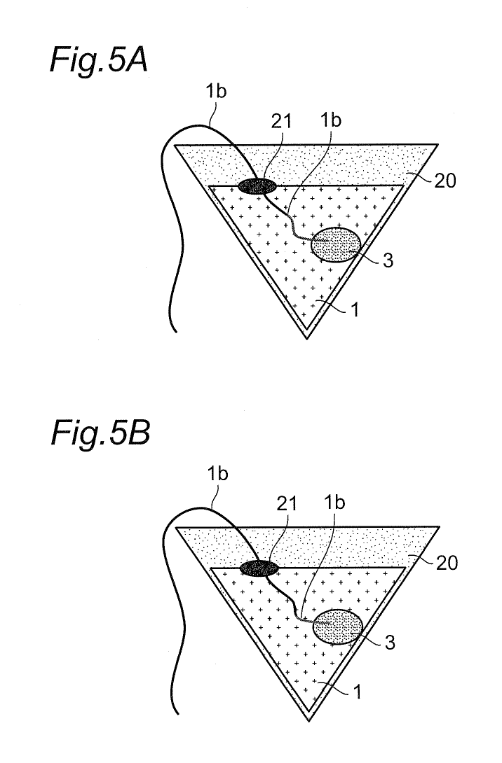

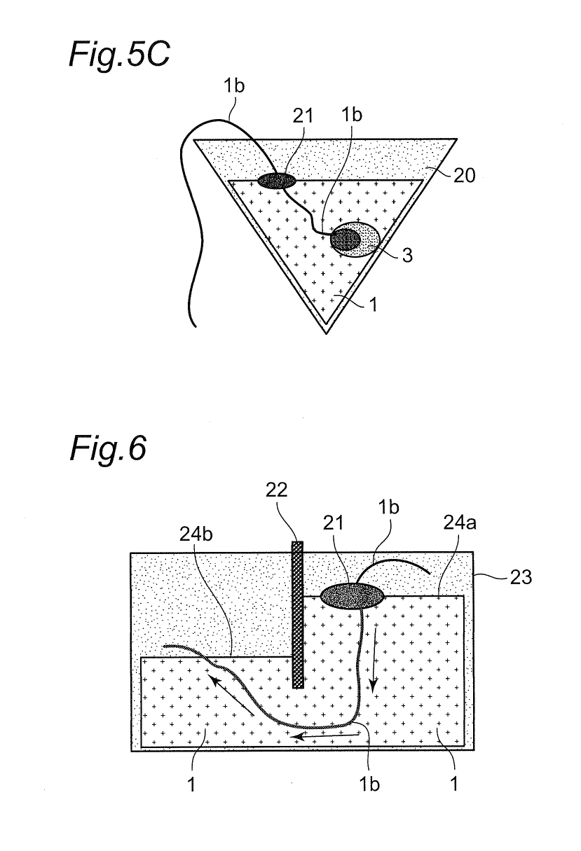

In FIGS. 4 to 5C, a water repellent sand layer 1 is provided in a container 20 having an inverted conical shape, and a water retaining layer 3 configured by ordinary sand (sand with no water repellent coating) is provided in the water repellent sand layer 1. A root 2b is set so as to pass in the water repellent sand layer 1 and connect the surface of the water repellent sand layer 1 and the water retaining layer 3. A glass funnel as a chemical tool was used in this case as the container 20 in the inverted conical shape. The root 2b was of pothos, which is a foliage plant. The water retaining layer 3 was provided in contact with the inner surface of the container 20 in the inverted conical shape so that change in color by water can be observed. The root 2b in the water repellent sand layer 1 was approximately 10 cm long. In the test, initially, a waterdrop 21 of 10 cc was laid on the upper surface of the water repellent sand layer 1 at a portion where the root 2b is located. Then, the waterdrop 21 having moved along the surface of the root 2b to reach the water retaining layer 3 was checked by change in color of the ordinary sand serving as the water retaining layer 3. In the root 2b shown in FIGS. 4 to 5C, the portion along which water moves is painted in black.

As a result, in the water repellent sand layer 1 having no water permeability, water was proved to move in several minutes. The water repellent sand layer 1 usually has water entry pressure of more than ten cmH₂O. Furthermore, as to be described later, even in a case where ordinary sand is mixed into sand with water repellent coating at one third or less, dropped water hardly moves in or enter the water repellent sand layer 1. In six minutes after the drop of water, slight change in color, in other words, arrival of water, was observed in the water retaining layer 3. Then, the portion with change in color was gradually expanded in the water retaining layer 3, and movement of water along the surface of the root 2b into the water retaining layer 3 was observed to the extent that it was clearly checked in about 30 minutes from the start. The test was continued further, and as a result, water 21 having been dropped on the upper surface of the water repellent sand layer 1 was entirely disappeared in about three hours. In consideration of evaporation speed, the entire waterdrop 21 is regarded as having moved to the water retaining layer 3. After four and a half hours from the start, it was checked that the entire region of the water retaining layer 3 having been set was changed in color. FIGS. 5A, 5B, and 5C sequentially show, as pattern views, how the water moves along the root 2b. It took six minutes from the state shown in FIG. 5A to the state shown in FIG. 5C, as mentioned above.

After three days, the water in the water retaining layer 3 was entirely evaporated and disappeared. The water retaining layer 3 was configured by ordinary sand. While water in the liquid form is unlikely to permeate the water repellent sand layer 1, gas like evaporated water is anticipated to easily pass through the water repellent sand layer 1. As having been proved, it is desired to contain a water retaining agent having a polymer material or the like in the water retaining layer 3 for actual plant cultivation, or to configure the water retaining layer 3 so as to prevent evaporation. However, if water around the root 2b is likely to be evaporated in the early stage, air necessary to cultivate the plant 2a can be supplied to the root 2b. Therefore, use of the water repellent sand layer 1 as a culture medium is remarkably effective. There is no concern of root rot or the like. In this test, because the container 20 has the inner wall made of hydrophilic glass, the water possibly moves along the inner wall surface of glass. Therefore, the system is configured such that water does not directly move from/to the water repellent sand layer 1 to/from the inner wall.

FIG. 6 shows another test system for explanation of the basic principle in the aspect of the present invention. In the test illustrated in FIG. 4, water might have possibly moved due to the water absorbing effect of the water retaining layer 3. However, in practical use, water needs to be supplied to the root 2b independently from the water retaining layer 3, or even in the period in which the root 2b has not yet reached the water retaining layer 3. In addition, the root 2b grows not only vertically downward (downward in the depth direction). The root 2b has tiny roots called root hairs, which are extremely small projections in the hair shapes from the surface of the root 2b. In particular, such root hairs will grow in all directions. In view of this, the test system shown in FIG. 6 was configured with no water retaining layer 3, so as to check whether or not water can move in directions other than vertically downward. Water repellent sand layers 1 having difference in height by a partition plate 22 were provided in a container 23 made of plastic, and a root 2b was set so as to be exposed from both of a high surface 24a and a low surface 24b and pass below the partition plate 22 made of plastic, which is provided for keeping the difference in height. Tested was whether or not water 21 dropped near the root 2b on the upper surface 24a of the high water repellent sand layer 1 could move along the root 2b in the water repellent sand layer 1 and reach the upper surface 24b of the low water repellent sand layer 1. The difference in height is about 3 cm. The root 2b run downward from the high surface by about 7 cm, passed below the difference in height, and run upward toward the low surface by about 4 cm. The root 2b had the portion in contact with the water repellent sand layers 1 of about 15 cm in total.

As a result, after about 15 minutes from the drop of water, visually checked was that the water permeated, though slightly, to the root 2b in the upper surface 24b of the low water repellent sand layer 1. In two hours later, the amount of water on the low surface was increased enough to form a waterdrop. After six hours from the start of the test, the water 21 on the high surface was entirely disappeared. In this test, because the container has the inner wall made of plastic having no water repellent property, the water possibly moves along the inner wall surface of the plastic container. Therefore, the system is configured such that water does not directly move from/to the water repellent sand layer 1 to/from the inner wall.

It was checked that water could move along the root 2b in the water repellent sand layer 1 without provision of the water retaining layer 3, unlimitedly to vertically downward.

In this case, the states of movement of water along the root 2b in about 15 minutes from the drop of water are similar to the illustrations in FIGS. 5A, 5B, and 5C. Accordingly, pattern views in this case are not provided.

The water repellent sand layer 1 is prepared by applying water repellent coating, with use of a chlorosilane-based fluorine-containing material, to Toyoura sand having an average particle diameter of about 150 μm. The water repellent sand layer 1 has approximately 130 degrees or more of a contact angle measured with pure water. Similar effects can be achieved independently from the type of sand, the particle diameter, or the type of a surface treatment compound. Water repellent coating may be applied with use of a chlorosilane-based material, an alkoxysilane-based material, or the like.

The water repellent sand layer 1 is configured only by water repellent sand to the surfaces of which water repellent coating is applied. However, effects similar to those of the case of including only water repellent sand can be achieved also in a case where sand with no water repellent coating is mixed with water repellent sand at a predetermined mass ratio.

For example, there is a report on a case of varying a mixing rate by mass (%) of water repellent sand obtained by applying water repellent coating to Toyoura sand having an average particle diameter of about 150 μm into sand with no water repellent coating. While water entry pressure (cm) was ˜31.8 cm at the mixing rate by mass of 0%, the water entry pressure was −23.7 cm at the mixing rate by mass of 25%, and the water entry pressure was −13.2 cm at the mixing rate by mass of 50%. The water entry pressure was +7.0 cm at the mixing rate by mass of 75%, and the water entry pressure was +12.0 cm at the mixing rate by mass of 100%. Because ordinary soil absorbs water, the ordinary soil has negative water entry pressure. On the other hand, because water repellent sand does not cause permeation without applying sufficient pressure, the water repellent sand has positive water entry pressure. The water repellent property will be exerted also in a case where sand with no water repellent coating is mixed at a mixing rate by mass of about 25%. Water will be absorbed in a case where sand with no water repellent coating is mixed at the mixing rate by mass of 50%. By approximation of these results, in a case where sand with no water repellent coating is mixed only at a mixing rate by mass of 30 to 350 or less, in other words, in the case where sand with no water repellent coating is mixed at about one third or less of the entire mass, it is possible to configure the water repellent sand layer 1 having the water repellent property. The water repellent sand layer 1 is configured only by water repellent sand to the surfaces of which water repellent coating is applied. However, similar effects can be achieved also in the case where sand with no water repellent coating is mixed at a mass ratio of about one third or less.

The mixing rate by mass is not constant because it is dependent on the water repellent coating material, the amount of coating, the particle diameter of sand, or the like.

### First Working Example

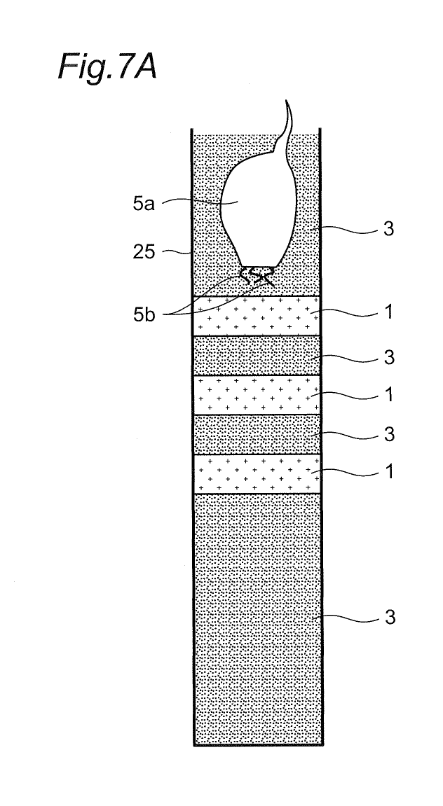

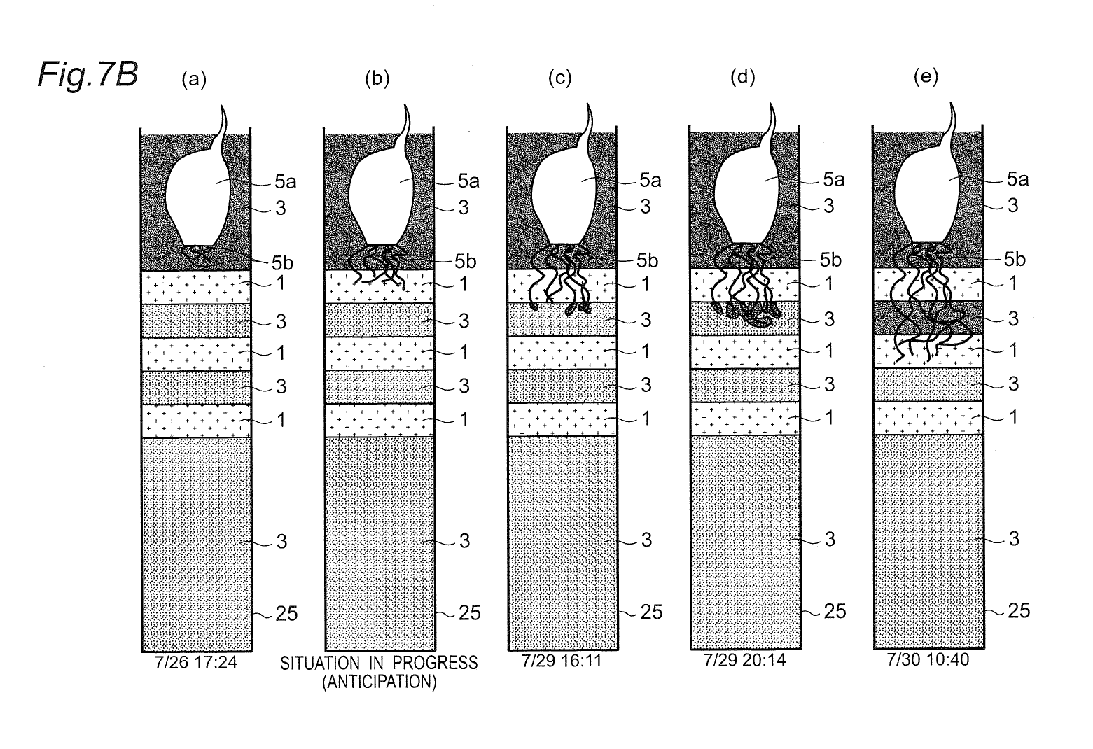

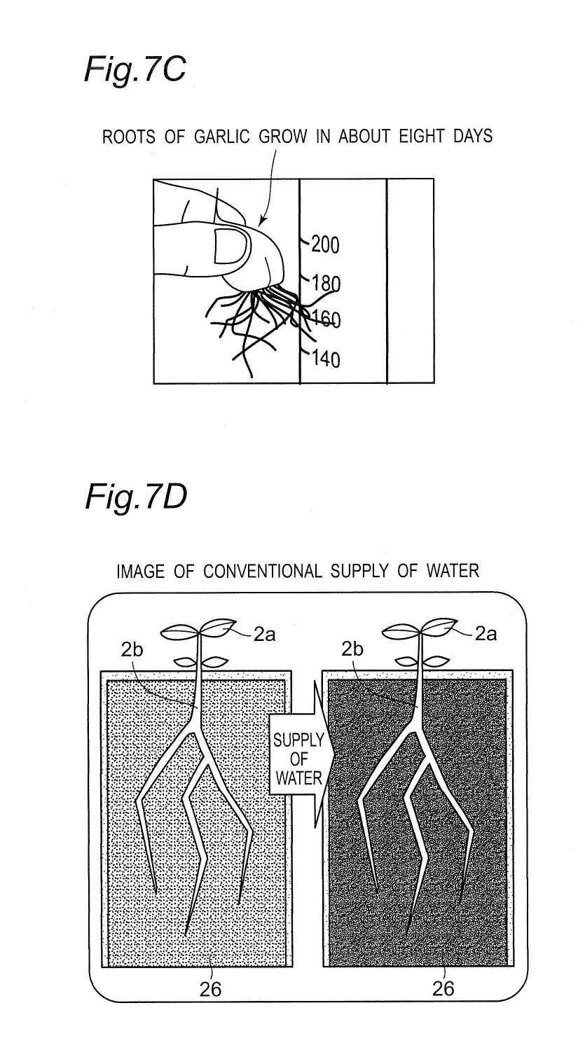

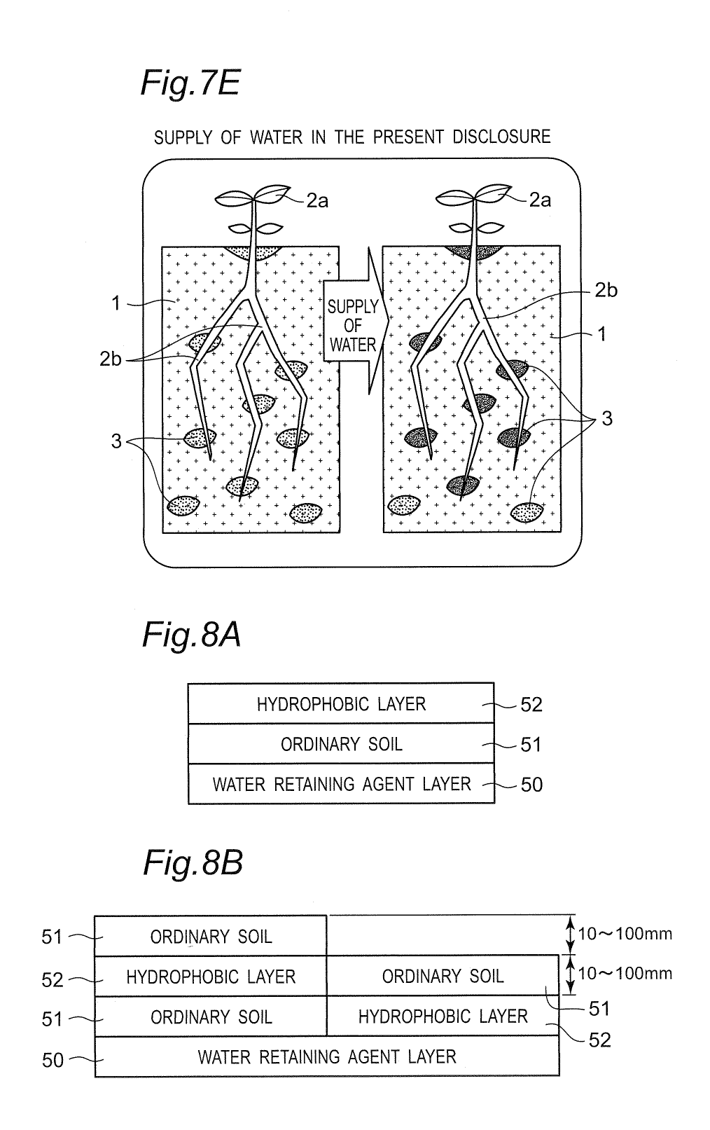

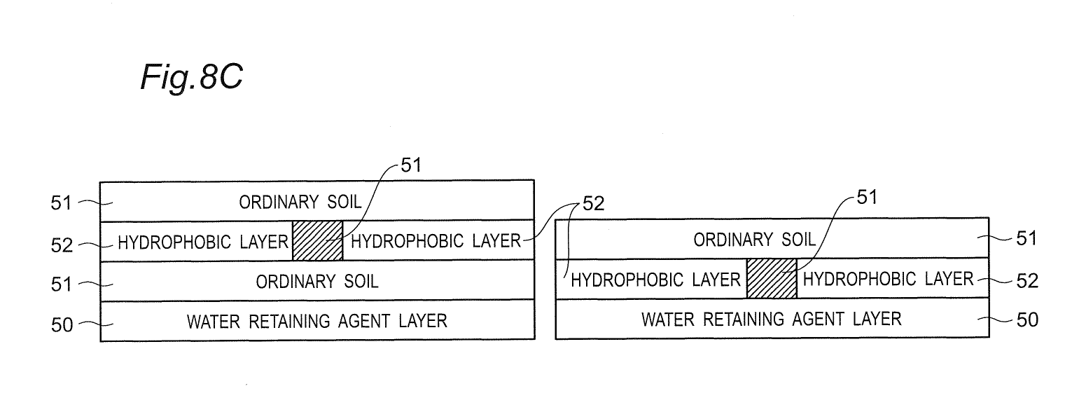

FIG. 7A illustrates the first example in connection with evaluation results on a plant in the plant cultivation structure according to the first embodiment of the present invention. FIG. 7A is a view showing a configuration that uses garlic 5a as an example of the plant 2a and sand as the plurality of layered water retaining layers 3. A test was actually performed in this configuration. In a measuring cylinder 25 of 200 cc, which is made of glass and has an inner wall with water repellent coating, the water retaining layer (first water retaining layer) 3 of ordinary sand was provided in the region from 160 to 200 cc, the layered water repellent sand (first water repellent sand) 1 was horizontally provided in the region from 150 to 160 cc therebelow, and the water retaining layer (second water retaining layer) 3 of ordinary sand was provided in the region from 140 to 150 cc therebelow. In the region from 140 cc to 110 cc therebelow, the water repellent sand (second water repellent sand) 1, the water retaining layer (third water retaining layer) 3, and the water repellent sand (third water repellent sand) 1 were alternately laminated in similar manners. The water retaining layer (fourth water retaining layer) 3 of ordinary sand was provided entirely in the region under 110 cc. In the uppermost water retaining layer (first water retaining layer) 3 in the region from 160 to 200 cc, two garlic plants 5a with rooting being observed were set such that generated roots 5b thereof were directed downward and the tip end thereof was located at the line of 170 cc. The garlic plants 5a are buried in the water retaining layer 3 of ordinary sand because plants are planted similarly in actual culture and the main bodies of the garlic plants 5a are prevented from floating on soil due to reaction by resistance of the soil upon the growth of the roots 5b.

FIG. 7B shows chronological illustrations of evaluation results in the configuration shown in FIG. 7A. After three days from the start of the test (see (c) in FIG. 7B), change in color by water was observed in the second water retaining layer 3 of ordinary sand that is provided in the region from 140 to 150 cc. The roots 5b grew in the first water repellent sand layer 1 with no water and reached the second water retaining layer 3, and then water supplied or water in the first water retaining layer 3 at the uppermost level would have moved along the roots 5b in the first water repellent sand layer 1. The inner wall of the container 25 had water repellent coating, and there was no trace of water having moved along the inner wall. It is necessary to evaluate with cultivation for a longer period of time, in order to verify the effects according to the aspect of the present invention in a configuration provided with many layers with the water retaining layers 3 located deeper.

FIG. 7C shows the roots 5b of the garlic plant 5a in eight days after rooting. While the garlic plant sprouted thereafter, no manure was provided. The test was completed in eight days in the configuration shown in FIG. 7A. It was observed that some of the longest roots 5b seemed to have grown enough to reach the third water retaining layer 3 provided in the region from 120 to 130 cc. However, in the water repellent sand layer 1 or the water retaining layer 3 having been hardened by including water, the roots 5b seem to actually grow while being bent.

FIGS. 7D and 7E are views for supplementary explanation of one of the features according to the aspect of the present invention, specifically, “enabling supply of requisite minimum water and manure as well as supply of air to roots of a plant”. FIG. 7D shows an image of supply of water in a conventional case. FIG. 7E shows an image of supply of water according to the aspect of the present invention.

In the conventional case shown in FIG. 7D, entire sand is configured by ordinary sand 26. Therefore, water was supplied inefficiently to a region where the roots had not yet reached, or a region where the roots would not pass later.

To the contrary, in the case of supply of water according to the aspect of the present invention shown in FIG. 7E, in the configuration in which the water retaining layers (ordinary sand) 3 are scattered in the entire water repellent sand layer 1, water is supplied only into the range of growth of the roots 2b. In addition, water is supplied to the water retaining layers 3 that are set by anticipating the requisite minimum amount of water calculated from the degree of growth of the roots 2b. In FIGS. 7D and 7E, the portions containing water are painted in black in the ordinary sand 26, the water retaining layers 3, and the like.

Generally, in addition to supply of water or water-based manure, air is essentially supplied to the roots 2b. Because the ordinary sand 26 exerts relatively good drainage, the fact that water is allowed to pass through sand is utilized in many cases. In particular, in a case where sand is used as a culture medium (also called sand culture) in hydroponic culture, water needs to be flown repetitively. Therefore, many inefficient measures are performed such as circulation after filtering. However, in the first embodiment of the present invention, only a requisite minimum amount of water is supplied, and also air can be very smoothly supplied to the roots 2b through the water repellent sand layer 1. These features are regarded as quite advantageous.

Because the garlic plants 5a do not prefer acid soil, magnesium lime is entirely dispersed on the portions to planted the garlic plants prior to cultivation in many cases. Also in the test illustrated in FIG. 7A, calcium carbonate is mixed in the first water retaining layer 3 of ordinary sand at the uppermost level. However, there is observed no particular influence on the growth of the roots 2b having been rooted. Water repellent coating is applied to the water repellent sand layer 1 with use of a chlorosilane-based compound. Accordingly, there was a concern of acidification due to a slight residue of a hydrochloric acid composition.

By properly combining the arbitrary embodiment(s) or modification(s) of the aforementioned various embodiments and modifications, the effects possessed by the embodiment(s) or modification(s) can be produced.

The present invention has been described in connection with the various embodiments and modifications thereof. It is certain that the present invention shall not be limited to such various embodiments and modifications.

The plant cultivation structure and the soil for plant cultivation according to the aspect of the present invention each include the water repellent sand obtained by applying water repellent coating to sand, the plant that is cultivated by growing roots in the water repellent sand, and the plurality of water retaining layers scattered (not mixed) in the water repellent sand, so that each of the roots grows to reach at least one of the water retaining layers. In this configuration, water and manure supplied to the plant in the region facing the outer surface of the water repellent sand move along the roots in the water repellent sand and reach the water retaining layers. Therefore, necessary water and manure are reserved in the water retaining layers in accordance with the growth of the roots, so that the plant can absorb the reserved water and manure through the roots. As a result, the plants can be cultivated with supply of requisite minimum water and manure to the plants individually in accordance with the different growth speeds of the respective plants. Furthermore, air is supplied from the water repellent sand to the peripheries of the roots while the water and the manure do not move. Therefore, the plant cultivation structure and the soil for plant cultivation are usefully applied. The plant cultivation structure and the soil for plant cultivation according to the aspect of the present invention are capable of supplying requisite minimum water and manure to any plant having growing roots, as well as are capable of supplying air to the roots of the plant.

The entire disclosure of Japanese Patent Application No. 2011-122999 filed on Jun. 1, 2011, including specification, claims, drawings, and summary are incorporated herein by reference in its entirety.

Although the present invention has been fully described in connection with the embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A plant cultivation structure comprising:
a water repellent sand layer that is formed by water repellent sand having surfaces to which water repellent coating is applied;
a plurality of water retaining layers scattered in the water repellent sand layer in a depth direction of the water repellent sand layer and capable of retaining water; and
a plant having roots located in the water repellent sand layer and being in contact with the water retaining layers such that the roots connect the plurality of water retaining layers.

2. The plant cultivation structure according to claim 1, wherein, in the plurality of water retaining layers, the water retaining layer in contact with the root of the plant retains water that is supplied from outside the water repellent sand layer to the plant and moves along the root of the plant.

3. The plant cultivation structure according to claim 1, wherein each of the water retaining layers contains a manure composition.

4. The plant cultivation structure according to claim 1, wherein the water retained in the water retaining layers contains a manure composition.

5. The plant cultivation structure according to claim 1, wherein the water retaining layers are formed by sand with no water repellent coating.

6. The plant cultivation structure according to claim 1, wherein each of the water retaining layers is formed into a downwardly convex circular arc shape in the depth direction.

7. The plant cultivation structure according to claim 1, wherein the water retaining layers are scattered and layered in the depth direction.

8. The plant cultivation structure according to claim 1, wherein the water repellent sand layer has a concavity for supply of water, in a surface in a portion where the plant is planted.

9. The plant cultivation structure according to claim 1, wherein the water repellent sand layer is formed by the water repellent sand having the surfaces to which water repellent coating is applied, and sand with no water repellent coating mixed thereto.

10. Soil for plant cultivation, comprising:
a water repellent sand layer that is formed by water repellent sand having surfaces to which water repellent coating is applied; and
a plurality of water retaining layers scattered in the water repellent sand layer in a depth direction of the water repellent sand layer and capable of retaining water, wherein
the water retaining layers are in contact with roots of a plant in the water repellent sand layer, the roots grow so as to connect the plurality of water retaining layers, and the water retaining layers retain water that is supplied from outside the water repellent sand layer to the plant and moves along the roots of the plant.

11. The soil for plant cultivation according to claim 10, wherein the water repellent sand layer is formed by the water repellent sand having the surfaces to which water repellent coating is applied, and sand with no water repellent coating mixed thereinto.
